(19) United States
(12) Patent Application Publication
(10) Pub. No.: US 2025/0054046 A1
(43) Pub. Date: Feb. 13, 2025

(54) INFORMATION RECOMMENDATION METHOD AND APPARATUS, COMPUTER DEVICE, AND STORAGE MEDIUM

(71) Applicant: Beijing Bytedance Network Technology Co., Ltd., Beijing (CN)

(72) Inventor: Ciqiong XU, Beijing (CN)

(21) Appl. No.: 18/720,580

(22) PCT Filed: Feb. 6, 2023
(86) PCT No.: PCT/CN2023/074530

§ 371 Date: Jun. 14, 2024

(30) Foreign Application Priority Data
Mar. 7, 2022 (CN) 202210225571.X

(51) Int. Cl. G06Q 30/0601

(52) U.S. Cl. CPC G06Q 30/0631

(57) ABSTRACT

The present disclosure provides an information recommendation method and apparatus, a computer device, and a storage medium. The method comprises: determining, in response to a search instruction for a first page, a product included in a multimedia content displayed on the first page; displaying, on a second page, at least one e-commerce recommendation word, the e-commerce recommendation word being generated based on the product and a keyword corresponding to at least one e-commerce attribute feature; receiving a trigger operation for the e-commerce recommendation word, and initiating, based on the e-commerce recommendation word and a vertical domain of content corresponding to the e-commerce recommendation word, a search request.

The present application claims the priority right of the Chinese patent application filed with the China Intellectual Property Administration on Mar. 7, 2022, having the application No. 202210225571.X and entitled “INFORMATION RECOMMENDATION METHOD AND APPARATUS, COMPUTER DEVICE, AND STORAGE MEDIUM”. The full disclosure of this Chinese patent application is incorporated in the present disclosure by reference.

### FIELD

The present disclosure relates to the field of Internet technology, and more specifically to an information recommendation method and apparatus, a computer device, and a storage medium.

### BACKGROUND

When browsing a multimedia content, a user may show interests in related objects involved in the multimedia content. In such case, if the user is interested in the clothes of the person appearing in a certain video and intends to know more relevant information of the clothes, he/she needs to initiate a search in accordance with attribute features of the displayed clothes.

Since the users can only see limited information directly from the multimedia content, it is quite hard to find the content they desired through the search initiated based on the directly observed information. Instead, they would try various possible search information, which ends up to a rather long search process with low target achievement rate.

### SUMMARY

Embodiments of the present disclosure at least provide an information recommendation method and apparatus, a computer device, and a storage medium.

In a first aspect, embodiments of the present disclosure provide an information recommendation method, comprising:
determining, in response to a search instruction for a first page, a product included in a multimedia content displayed on the first page;
displaying, on a second page, at least one e-commerce recommendation word, the e-commerce recommendation word being generated based on the product and a keyword corresponding to at least one e-commerce attribute feature;
receiving a trigger operation for the e-commerce recommendation word, and initiating based on the e-commerce recommendation word and a vertical domain of content corresponding to the e-commerce recommendation word, a search request.

In an optional implementation, the e-commerce attribute feature is determined by:
determining, in accordance with a product type of the product, respective service providers matching the product type;
determining, in accordance with current attribute state features of the determined respective service providers, the e-commerce attribute feature meeting a recommendation condition.

In an optional implementation, the e-commerce recommendation word is determined by:

obtaining candidate recommendation words associated with the product;

selecting, from the candidate recommendation words, a candidate recommendation word that matches a determined e-commerce attribute feature as the e-commerce recommendation word.

In an optional implementation, the multimedia content is a video, and determining a product included in a multimedia content displayed on the first page includes:
extracting text descriptive information in the video, and determining, based on the text descriptive information, a product associated with the video; and/or
identifying each entity in respective key frame images of the video, and determining a product in each entity identified.

In an optional implementation, the multimedia content is an image-text content describing a product, and determining a product included in a multimedia content displayed on the first page includes:
determining, based on product descriptive information in the image-text content, a product associated with the image-text content; and/or performing product identification on an image in the image-text content, and determining a product identified.

In an optional implementation, the method further comprises:
when it is determined that the multimedia content includes a plurality of products, selecting, based on current behavior data for the first page and/or authorized historical behavior data of a user, a target product from the plurality of products to determine the e-commerce recommendation word.

In an optional implementation, displaying, on a second page, at least one e-commerce recommendation word includes:
displaying, in a first region of the second page, a first e-commerce recommendation word, the first region being a region corresponding to a search box;
displaying, in a second region of the second page, a second e-commerce recommendation word;
wherein a correlation between the first e-commerce recommendation word and the product is greater than a correlation between the second e-commerce recommendation word and the product.

In an optional implementation, the e-commerce recommendation word further includes a third e-commerce recommendation word determined based on the e-commerce attribute feature and irrelevant to the product;
displaying, on a second page, at least one e-commerce recommendation word includes:
displaying, in a third region of a second page, the third e-commerce recommendation word.

In an optional implementation, the method, after initiating, based on the e-commerce recommendation word and a vertical domain of content corresponding to the e-commerce recommendation word, a search request, further comprises:
displaying, under the vertical domain of content of a third page, a search result corresponding to the e-commerce recommendation word.

In a second aspect, embodiments of the present disclosure also provide an information recommendation apparatus, comprising:
a determination module for determining, in response to a search instruction for a first page, a product included in a multimedia content displayed on the first page;
a first display module for displaying, on a second page, at least one e-commerce recommendation word, the e-commerce recommendation word being generated based on the product and a keyword corresponding to at least one e-commerce attribute feature;
a sending module for receiving a trigger operation for the e-commerce recommendation word, and initiating, based on the e-commerce recommendation word and a vertical domain of content corresponding to the e-commerce recommendation word, a search request.

In an optional implementation, the e-commerce attribute feature is determined by:
determining, in accordance with a product type of the product, respective service providers matching the product type;
determining, in accordance with current attribute state features of the determined respective service providers, the e-commerce attribute feature meeting a recommendation condition.

In an optional implementation, the e-commerce recommendation word is determined by:
obtaining candidate recommendation words associated with the product;
selecting, from the candidate recommendation words, a candidate recommendation word that matches a determined e-commerce attribute feature as the e-commerce recommendation word.

In an optional implementation, the multimedia content is a video and the determination module is provided for extracting text descriptive information in the video, and determining, based on the text descriptive information, a product associated with the video; and/or
identifying each entity in respective key frame images of the video, and determining a product in each entity identified.

In an optional implementation, the multimedia content is an image-text content describing a product, and the determination module is provided for determining, based on product descriptive information in the image-text content, a product associated with the image-text content; and/or performing product identification on an image in the image-text content, and determining a product identified.

In an optional implementation, the determination module further includes when it is determined that the multimedia content includes a plurality of products, selecting, based on current behavior data for the first page and/or authorized historical behavior data of a user, a target product from the plurality of products to determine the e-commerce recommendation word.

In an optional implementation, the first display module is used for displaying, in a first region of the second page, a first e-commerce recommendation word, the first region being a region corresponding to a search box;
displaying, in a second region of the second page, a second e-commerce recommendation word;
wherein a correlation between the first e-commerce recommendation word and the product is greater than a correlation between the second e-commerce recommendation word and the product.

In an optional implementation, the e-commerce recommendation word further includes a third e-commerce recommendation word determined based on the e-commerce attribute feature and irrelevant to the product;

The first display module is used for displaying, in a third region of a second page, the third e-commerce recommendation word.

In an optional implementation, the apparatus further includes a second display module for displaying, under the vertical domain of content of a third page, a search result corresponding to the e-commerce recommendation word, after initiating, based on the e-commerce recommendation word and a vertical domain of content corresponding to the e-commerce recommendation word, a search request.

In a third aspect, embodiments of the present disclosure also provide a computer device, comprising: a processor, a memory, and a bus; wherein the memory stores machine-readable instructions executable by the processor; during operation of computer device, the processor communicates with the memory via the bus; the machine-readable instructions, when executed by the processor, perform the above first aspect or steps of any possible information recommendation method according to the first aspect.

In a fourth aspect, embodiments of the present disclosure also provide a computer-readable storage medium having computer programs stored thereon, the computer programs, when executed by a processor, performing the above first aspect or steps of any possible information recommendation method according to the first aspect.

Effects of the above information recommendation apparatus, computer device, and storage medium may refer to the above explanation of the information recommendation method and will not be covered here.

Embodiments of the present disclosure provide an information recommendation method and apparatus, a computer device, and a storage medium. The method comprises: determining, in response to a search instruction for a first page, a product included in a multimedia content displayed on the first page; displaying, on a second page, at least one e-commerce recommendation word, the e-commerce recommendation word being generated based on the product and a keyword corresponding to at least one e-commerce attribute feature; receiving a trigger operation for the e-commerce recommendation word, and initiating, based on the e-commerce recommendation word and a vertical domain of content corresponding to the e-commerce recommendation word, a search request.

In other words, in accordance with the embodiments of the present disclosure, in response to a search instruction for a first page, a product included in the multimedia content can be determined from a multimedia content displayed on the first page, and an e-commerce recommendation word is determined based on the product and at least one e-commerce attribute feature; and at least one e-commerce recommendation word is displayed on a second page. Accordingly, a solution for searching products involved in the multimedia content may be automatically provided for the users. When the users are browsing the multimedia content, a search for the product in the multimedia content can be initiated in time, to gain information about the product involved in the multimedia content and further improve search efficiency and target achievement rate of the search.

The above objectives, characteristics and advantages of the present disclosure will be more easily understood by listing the following preferred embodiments. Detailed description of the preferred embodiments is also provided below with reference to the accompanying drawings.

### BRIEF DESCRIPTION OF THE DRAWINGS

To describe the technical solutions in the embodiments of the present disclosure more clearly, the drawings to be used in the embodiments are briefly introduced below. The drawings here are incorporated into the description as a part of it. These drawings illustrate embodiments according to the present disclosure and further explain the technical solutions of the present application in combination with the description. It is to be understood that the following drawings only illustrate some embodiments of the present disclosure and shall not be regarded as limitations over the scope. Those skilled in the art also may obtain other related drawings from the illustrated ones without any exercises of inventive work.

FIG. 1 illustrates a flowchart of the information recommendation method provided by embodiments of the present disclosure;

FIG. 2 illustrates a schematic diagram of display of the first page provided by embodiments of the present disclosure;

FIG. 3 illustrates a schematic diagram of display of the second page provided by embodiments of the present disclosure;

FIG. 4 illustrates a schematic diagram of display of a search result page provided by embodiments of the present disclosure;

FIG. 5 illustrates a schematic diagram of an information recommendation apparatus provided by embodiments of the present disclosure;

FIG. 6 illustrates a structural diagram of a computer device provided by embodiments of the present disclosure.

### DETAILED DESCRIPTION OF EMBODIMENTS

For a clearer picture of the objectives, technical solutions and advantages of the embodiments of the present disclosure, the technical solutions in the embodiments of the present disclosure are to be described clearly and completely with reference to the drawings in the embodiments of the present disclosure. It is obvious that the described embodiments are only part of the embodiments of the present disclosure, rather than all of them. In general, components of the embodiments of the present disclosure described and illustrated here may be arranged and designed by various configurations. Thus, the following detailed description of the embodiments of the present disclosure provided in the drawings is not intended to restrict the protection scope of the present disclosure. It is merely a description of the selected embodiments of the present disclosure. All other embodiments obtained by those skilled in the art on the basis of the illustrated embodiments of the present disclosure without any exercises of inventive work fall within the protection scope of the present disclosure.

Besides, the terms “first”, “second” and the like are used in the description and the claims of the embodiments of the present disclosure and in the above drawings for distinguishing the similar objects, rather than specifying a particular sequence or order. It should be appreciated that data utilized in such manner may exchange with one another in suitable cases, such that the embodiments described here can be implemented in an order other than the one illustrated or described here.

“Plural or several” stated in the text indicates two or more. The term “and/or” describes an association between related objects and suggests three relations. For example, A and/or B may indicate three scenarios, including A alone, both A and B and B alone. The character “/” usually indicates an “OR” relation between the objects linked by it.

It is investigated by research that when users browse a certain multimedia content, only limited information can be seen from the multimedia content. As such, if the users are interested in a certain object in the multimedia content, they initiate a search merely based on the directly observed information. But it is quite hard to find the content they desired through the above search. Instead, they would try various possible search information, which ends up to a rather long search process with low target achievement rate.

Based on the above research, the present disclosure provides an information recommendation method, comprising: determining, in response to a search instruction for a first page and from a multimedia content displayed on the first page, a product included in the multimedia content, and determining an e-commerce recommendation word based on the product and at least one e-commerce attribute feature; and displaying at least one e-commerce recommendation word on a second page. In other words, a solution for searching products involved in the multimedia content may be automatically provided for the users. When the users are browsing the multimedia content, a search for the product in the multimedia content can be initiated in time, to gain information about the product involved in the multimedia content and further improve search efficiency and target achievement rate of the search.

Defects in the above solutions are discovered by inventors through practice and careful research. In such case, the process of discovering the above problems and the solutions to the problems proposed by the present disclosure below should be considered as contributions of the inventors to the present disclosure.

It is to be noted: similar reference signs and letters indicate similar items in the following drawings. Therefore, once an item is defined in a drawing, no further definitions and explanations are required in the subsequent drawings.

To easily understand an embodiment, an information recommendation method disclosed by this embodiment of the present disclosure is elaborated in the first place. The information recommendation method provided by the embodiments of the present disclosure is generally executed by a computer device with computing power. The computer device for example includes: a terminal device or a server or other processing devices. In some possible implementations, the processor calls computer-readable instructions stored in the memory to implement the information recommendation method.

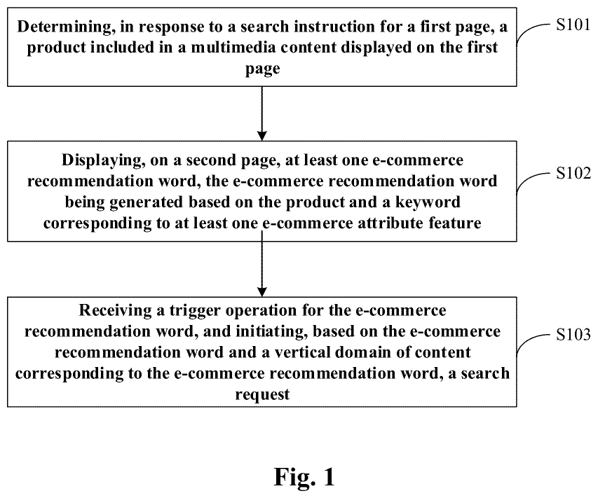

FIG. 1 illustrates a flowchart of an information recommendation method provided by embodiments of the present disclosure and the method includes steps S101-S103, wherein:

S101: determining, in response to a search instruction for a first page, a product included in a multimedia content displayed on the first page.

In this step, the multimedia content may include one or more of videos, live broadcasts, articles and news displayed in the first page. Correspondingly, the first page may be a webpage or an application page. To be specific, one or more multimedia contents may be displayed in the first page.

In specific implementations, while browsing the multimedia content, the users may directly initiate a search on the first page. By parsing or entity-identifying the multimedia content, products included in the multimedia content may be determined. Initiating the search on the first page, for example, may refer to triggering search options (e.g., search button and search box) in the first page or triggering the multimedia content in the first page etc.

Optionally, a search box may be displayed in the first page. By triggering the search box displayed in the first page, the users may specifically trigger a search identifier in the search box, to initiate a search request for the products included in the multimedia content. In other words, in response to the users triggering a search identifier in the search box, the multimedia content is identified to further determine the products included in the multimedia contents.

Besides, e-commerce recommendation words related to the determined products may be displayed in the search box, to remind the users that the products involved in the multimedia contents may be searched based on the provided e-commerce recommendation words. The e-commerce recommendation words may be generated based on the products in the multimedia contents and the keyword corresponding to at least one e-commerce attribute feature.

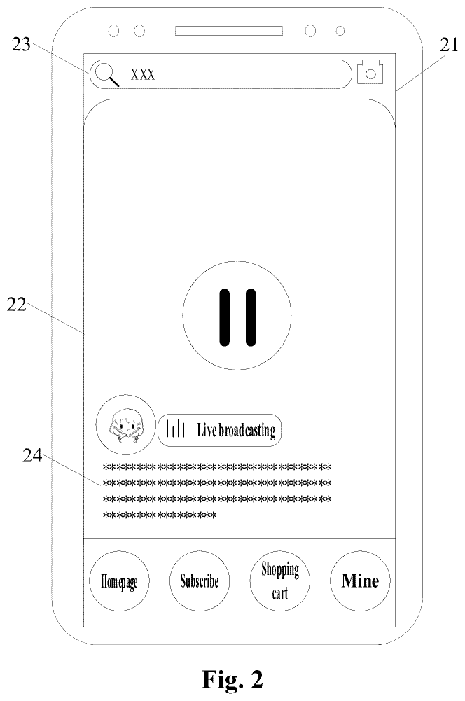

FIG. 2 is a schematic diagram of display of the first page, including a first page 21, a multimedia content 22 (demonstrated in the form of video) and a search box 23.

The multimedia content may include videos and image-text contents etc. Products included in the multimedia content may be determined according to any one or more of the following A1-A6:

In case that the multimedia content is a video, the products included in the multimedia contents may be determined with reference to A1-A3; in case that the multimedia content is image-text content, the products included in the multimedia content may be determined with reference to A4-A6, wherein:

A1: in case that the multimedia content is a video, text descriptive information (as illustrated by 24 in FIG. 2) in the video may be extracted and video-related products are determined based on the text descriptive information.

Here, the text descriptive information in the video may include subject information, content summary information and user comment information of the video.

The video-related product is determined based on the text descriptive information. Specifically, product descriptive information, such as product keyword or information characterizing the product, may be directly extracted from the text descriptive information. At this moment, the product indicated by the product descriptive information is the determined video-related product.

If the extracted product descriptive information includes a plurality of different products, the product included in the multimedia content may also be determined with reference to the product displayed in the video.

As an example, the text descriptive information says “summer is here, and floral skirts and white shoes may create a better outfit”; if the extracted product descriptive information includes floral skirts and white shoes, it is determined that the products included in the multimedia content are floral skirts and white shoes. Alternatively, with further reference to the products displayed in the video, for example floral skirts going with white shoes as highlights displayed in the video (possibly only one pair of white shoes matching with plural sets of dresses), it is determined that the white shoe is the video-related product.

A2: in case that the multimedia content is a video, each entity in respective key frame images of the video is identified and product in each identified entity is determined.

Here, entity displayed in the key frame images may include persons and various objects etc. The entity corresponding to the product may be selected from various entities identified. For instance, the key frame images display a person wearing clothes of a given brand. The identified entity here includes a person and clothes of a given brand, wherein the clothes of a given brand are products in the identified entity.

A3: in case that the multimedia content is image-text content, the product related to the image-text content may be determined based on the product descriptive information in the image-text content (as demonstrated by 24 in FIG. 2).

The image-text content may include image and/or text content, wherein the image may be a picture of the displayed product; and the text may be product descriptive information; for example, the image-text multimedia content may specifically include a product image and descriptive information for product in the product image.

The product descriptive information may be identified using a semantic recognition algorithm to determine the product related to the image-text content.

A4: in case that the multimedia content is image-text content, the product in the image of the image-text content is identified, to determine the identified product.

Product in the image may be identified using an image recognition algorithm to determine the product displayed in the image.

When it is determined that only one product is included in the multimedia content, S102 may be directly executed.

When it is determined that the multimedia content includes a plurality of products, a target product may also be selected from the plurality of products based on current behavior data for the first page and/or authorized historical behavior data of a user. The target product may be used for determining the e-commerce recommendation words displayed in the search box, i.e., S102 is executed.

Here, the current behavior data may include a behavior of putting the product in a favorite list via a favorite link of the product in the first page and a behavior of pre-purchase by the user etc. The authorized historical behavior data may include trigger and purchase of the product, adding the product to the favorite list, and watching live broadcasts of sales of products. A product matching behavior data of the user is selected from a plurality of products. For example, a target product may be a product on which the largest amount of the above behaviors is performed among the plurality of products. Or a weight may be set for each behavior. In such case, a product corresponding to the highest interactive score (i.e., weighted sum of the amount of the corresponding behavior performed) is calculated as the target product.

S102: displaying, on a second page, at least one e-commerce recommendation word, the e-commerce recommendation word being generated based on the product and a keyword corresponding to at least one e-commerce attribute feature.

The e-commerce recommendation word may be generated based on the product and the keyword corresponding to the at least one e-commerce attribute feature, wherein the e-commerce attribute feature may include brand, activity, state of supply party, product style, product type and the like, the state of supply party consisting of live broadcast state and pre-sale state etc.

The above e-commerce attribute feature may be determined as follows:

In view of the product type of the product, respective service suppliers matching the product type may be determined; product type for example may include clothes, cosmetics, foods and accessories etc. The service supplier, for example, may be respective business matching the product type.

After that, the e-commerce attribute feature meeting a recommendation condition may be determined in accordance with current attribute state features of respective service suppliers determined. The current attribute state features of the service suppliers, for example, may include brand popularity of the service supplier, whether a specific event is being held at present, sales volume of the product, and whether there is a live broadcast at the moment etc. The recommendation condition, for example, may include at least one of: there is an event going on; the brand popularity (calculated on the basis of access amount and purchase amount) reaching a preset popularity threshold; the sales volume of the product reaching a preset sales volume threshold, and there is a live broadcast at the present etc.

As an example, if a certain service supplier is currently live broadcasting, it may be determined that the e-commerce attribute feature of the service supplier includes live broadcast information of the service supplier. If the brand popularity of the current service supplier meets the condition, it may be determined that the e-commerce attribute feature of the service supplier includes brand information of the service provider.

Here, a plurality of e-commerce attribute features meeting the recommendation condition may be determined.

The above e-commerce recommendation word may be determined as follows:

First, candidate recommendation words associated with the product may be obtained; and then a candidate recommendation word satisfying the determined e-commerce attribute feature is selected from the candidate recommendation words as the e-commerce recommendation word.

Candidate recommendation words associated with the product may be stored in advance. For example, in terms of product A, its brand may serve as the candidate recommendation word; the style of the product A may act as the candidate recommendation word; supplier of the product A may be the candidate recommendation word; activity of the product A at the current time may act as the candidate recommendation word. Subsequently, a candidate recommendation word satisfying the determined e-commerce attribute feature is selected from the candidate recommendation words as the e-commerce recommendation word. Continuing with the above example, if the determined e-commerce attribute feature is an activity of a trending topic, this activity of trending topic and/or the product under the activity of trending topic may be determined as the e-commerce recommendation word; if the determined e-commerce attribute feature is a most-searched brand, the most-searched brand and/or the product A under the most-searched brand may be determined as the e-commerce recommendation word.

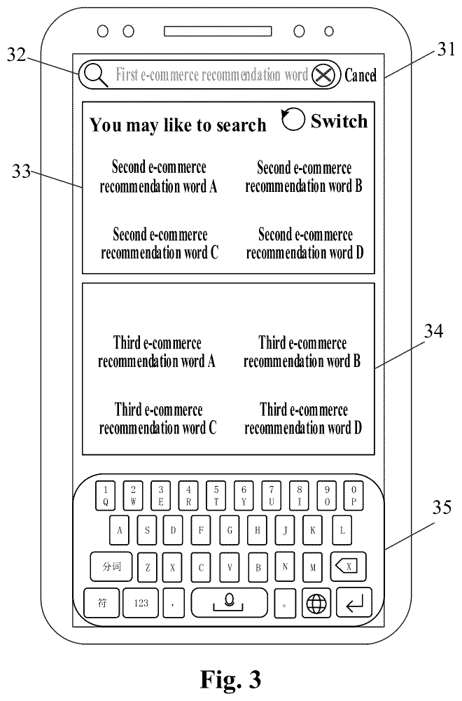

FIG. 3 illustrates a schematic diagram of display of a second page. The second page may be divided into a plurality of regions and different e-commerce recommendation words are displayed respectively in various regions. According to FIG. 3, the second page 31 includes a first region 32 and a second region 33.

A first e-commerce recommendation word may be displayed in a first region of the second page, wherein the first page is a region corresponding to a search box; a second e-commerce recommendation word is displayed in a second region of the second page; wherein a correlation between the first e-commerce recommendation word and the product is greater than a correlation between the second e-commerce recommendation word and the product.

Here, correlation may include a matching degree between the product information characterized by the e-commerce recommendation word and the above determined product. For example, a semantic similarity between the e-commerce recommendation word and the keyword corresponding to the product may be calculated as the correlation. Alternatively, a similarity between a result of search based on the e-commerce recommendation word as the search information and a result of search based on the picture or keyword corresponding to the above product as the search information may be calculated as the correlation.

In some embodiments, the first e-commerce recommendation word may be virtually displayed in the first region, and the first e-commerce recommendation word virtually displayed in the first region is to indicate the users that a search request may be initiated based on a recommendation word that is more popular than the second e-commerce recommendation word.

In some embodiments, the second page 31 further includes a third region 34. A third e-commerce recommendation word is displayed in the third region of the second page, wherein the third e-commerce recommendation word may be an e-commerce recommendation word determined on the basis of the e-commerce attribute feature and irrelevant to the product.

The third e-commerce recommendation word may be an e-commerce recommendation word determined based on the e-commerce attribute feature and related to e-commerce intentions. For example, if an application launches a series of events irrelevant to the product in the current period of time, the series of events may serve as the third e-commerce recommendation word.

In some embodiments, the second page also may include a fourth region, in which a fourth e-commerce recommendation word is displayed, wherein the fourth e-commerce recommendation word may include search keywords in a history search record of the user.

In some embodiments, in response to an operation of inputting information for the first region, new search information may be determined; the new search information may be obtained from an editing operation on the basis of the first e-commerce recommendation word; or may be search information of a corresponding intention re-input by the user. As shown in FIG. 3, a soft keyboard 35 may be called for entry of information. Afterwards, the search request may be initiated based on the input search information and vertical domain of content corresponding to the e-commerce recommendation word.

S103: receiving a trigger operation for the e-commerce recommendation word, and initiating, based on the e-commerce recommendation word and a vertical domain of content corresponding to the e-commerce recommendation word, a search request.

In this step, vertical domain of content corresponding to the e-commerce recommendation word may include product class, live broadcast class and comprehensive search class and the like.

The search request is initiated based on the e-commerce recommendation word and the vertical domain of content corresponding to the e-commerce recommendation word. As an example, when a trigger operation for the e-commerce recommendation word is received, the e-commerce recommendation word and the vertical domain of content corresponding thereto serve as the search condition to initiate the search request. A search result for respective classes of the product recommendation word may be obtained, such as product indicated by the product recommendation word in the product class, live broadcast of the product indicated by the product recommendation word in the live broadcast class, and comprehensive search result of the product indicated by the product recommendation word in the class of comprehensive search.

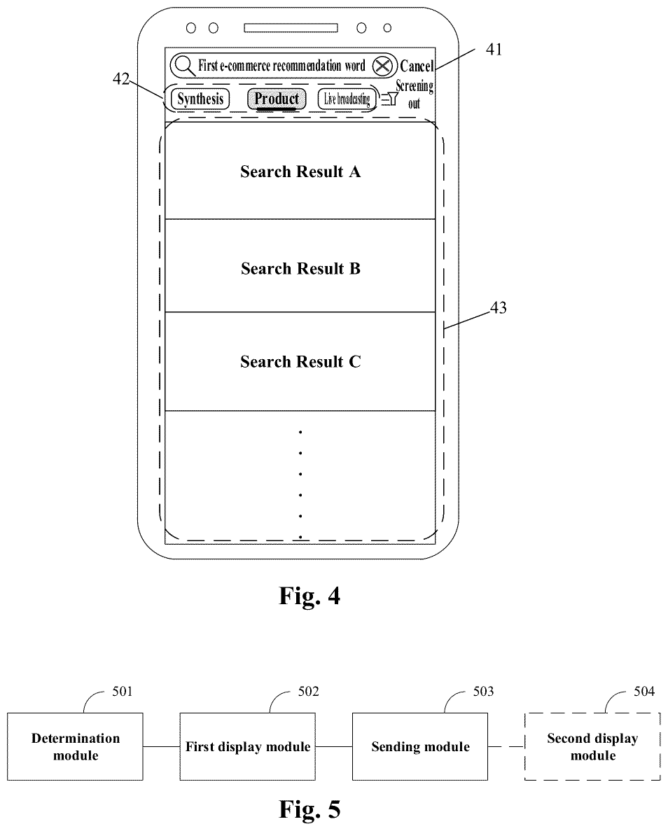

After the search request is initiated, a search result corresponding to the e-commerce recommendation word also may be displayed under the vertical domain of content of the third page. FIG. 4 illustrates a schematic diagram of display of a search result page, and a search result in the class of product is demonstrated, including a third page 41, a vertical domain of content 42 and a plurality of search results 43.

Through the above steps S101-S103, in response to a search instruction for a first page, a product included in the multimedia content is determined from a multimedia content displayed on the first page, and an e-commerce recommendation word is determined based on the product and at least one e-commerce attribute feature; and at least one e-commerce recommendation word is displayed on a second page. In other words, a solution for searching products involved in the multimedia content may be automatically provided for the users. When the users are browsing the multimedia content, a search for the product in the multimedia content can be initiated in time, to gain information about the product involved in the multimedia content and further improve search efficiency and target achievement rate of the search.

Those skilled in the art may appreciate that although the respective steps are drafted in a given order in the above method of the specific implementations, it does not mean the steps should be strictly executed in such order. Instead the drafting order makes no limitations over the implementation process. The specific execution order of the respective steps should be determined by their functions and possible internal logic.

On the basis of the same inventive concept, embodiments of the present disclosure also provide an information recommendation apparatus corresponding to the information recommendation method. Because the principle followed by the apparatus in the embodiments of the present disclosure is similar to the above information recommendation method according to the embodiments of the present disclosure, the implementation of the apparatus may refer to how the method is implemented and the same contents will not be covered here.

FIG. 5 illustrates a schematic diagram of an information recommendation apparatus provided by embodiments of the present disclosure. The apparatus comprises: a determination module 501, a first display module 502 and a sending module 503; wherein,
a determination module 501 for determining, in response to a search instruction for a first page, a product included in a multimedia content displayed on the first page;
a first display module 502 for displaying, on a second page, at least one e-commerce recommendation word, the e-commerce recommendation word being generated based on the product and a keyword corresponding to at least one e-commerce attribute feature;
a sending module 503 for receiving a trigger operation for the e-commerce recommendation word, and initiating, based on the e-commerce recommendation word and a vertical domain of content corresponding to the e-commerce recommendation word, a search request.

In an optional implementation, the e-commerce attribute feature is determined by:
determining, in accordance with a product type of the product, respective service providers matching the product type;
determining, in accordance with current attribute state features of the determined respective service providers, the e-commerce attribute feature meeting a recommendation condition.

In an optional implementation, the e-commerce recommendation word is determined by:
obtaining candidate recommendation words associated with the product;
selecting, from the candidate recommendation words, a candidate recommendation word that matches a determined e-commerce attribute feature as the e-commerce recommendation word.

In an optional implementation, the multimedia content is a video and the determination module 501 is provided for extracting text descriptive information in the video, and determining, based on the text descriptive information, a product associated with the video; and/or
identifying each entity in respective key frame images of the video, and determining a product in each entity identified.

In an optional implementation, the multimedia content is an image-text content describing a product, and the determination module 501 is provided for determining, based on product descriptive information in the image-text content, a product associated with the image-text content; and/or performing product identification on an image in the image-text content, and determining a product identified.

In an optional implementation, the determination module 501 further includes when it is determined that the multimedia content includes a plurality of products, selecting, based on current behavior data for the first page and/or authorized historical behavior data of a user, a target product from the plurality of products to determine the e-commerce recommendation word.

In an optional implementation, the first display module 502 is used for displaying, in a first region of the second page, a first e-commerce recommendation word, the first region being a region corresponding to a search box;
displaying, in a second region of the second page, a second e-commerce recommendation word;
wherein a correlation between the first e-commerce recommendation word and the product is greater than a correlation between the second e-commerce recommendation word and the product.

In an optional implementation, the e-commerce recommendation word further includes a third e-commerce recommendation word determined based on the e-commerce attribute feature and irrelevant to the product;

The first display module 502 is used for displaying, in a third region of a second page, the third e-commerce recommendation word.

In an optional implementation, the apparatus further includes a second display module 504 for displaying, under the vertical domain of content of a third page, a search result corresponding to the e-commerce recommendation word, after initiating, based on the e-commerce recommendation word and a vertical domain of content corresponding to the e-commerce recommendation word, a search request.

The processing procedure of respective modules in the apparatus and interactive process between the respective modules may refer to the related description in the above method embodiments and will not be covered here.

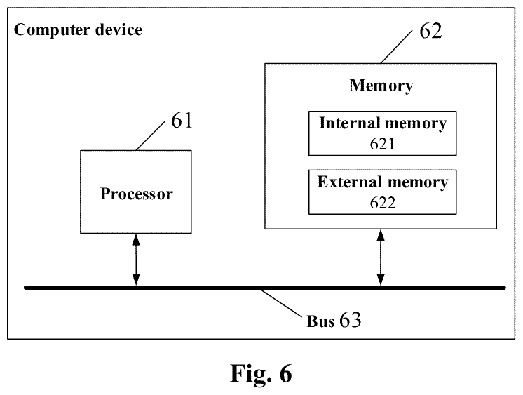

Based on the same inventive concept, embodiments of the present disclosure also provide a computer device. FIG. 6 illustrates a structural diagram of the computer device provided by embodiments of the present disclosure, comprising:

A processor 61, a memory 62 and a bus 63, wherein the memory 62 stores machine-readable instructions executable by the processor 61 and the processor executes the machine-readable instructions stored in the memory 62; when the machine-readable instructions are executed by the processor 61, the processor 61 perform the following steps of: S101: determining, in response to a search instruction for a first page, a product included in a multimedia content displayed on the first page; S102: displaying, on a second page, at least one e-commerce recommendation word, the e-commerce recommendation word being generated based on the product and a keyword corresponding to at least one e-commerce attribute feature; S103: receiving a trigger operation for the e-commerce recommendation word, and initiating, based on the e-commerce recommendation word and a vertical domain of content corresponding to the e-commerce recommendation word, a search request.

The above memory 62 consists of an internal memory 621 and an external memory 622; the internal memory 621 here is used for temporarily storing the operational data in the processor 61 and data exchanged with the external memory 622 (such as hard disk and the like). The processor 61 exchanges data through the internal memory 621 and the external memory 622. During the operation of the computer device, the processor 61 communicates with the memory 62 through the bus 63, to enable the processor 61 to perform the execution instructions mentioned in the above method embodiments.

Embodiments of the present disclosure also provide a computer-readable storage medium having computer programs stored thereon, wherein the computer programs, when operated by the processor, perform steps of the information recommendation method in the above method embodiments. The storage medium may be volatile or non-volatile computer-readable storage medium.

Embodiments of the present disclosure further provide a computer program product, comprising computer instructions, which computer instructions when executed by the processor implement the steps of the above information recommendation method, wherein the computer program product may be any products capable of implementing the above information recommendation method. Part or all of the solutions making contributions to the prior art in the computer program product may be embodied in the form of software product (e.g., Software Development Kit, SDK). The software product may be stored in a storage medium, to enable the related device or processor to perform part or all of the steps in the above information recommendation method through the included computer instructions.

It may be clearly understood by those skilled in the art that, for sake of an easy and concise description, a detailed working process of the above described apparatus may refer to a corresponding process in the foregoing method embodiments. Details are not described herein again. In the several embodiments provided by the present disclosure, it should be understood that the disclosed apparatus and method may be implemented in other manners. The above described apparatus embodiment is merely an example. For example, the module division is merely a division by logic function and there may be other dividing approaches in actual implementation. For another example, a plurality of modules or components may be combined, or some features may be ignored or not performed. In addition, the displayed or discussed mutual couplings or direct couplings or communication links may be implemented through some interfaces. The indirect couplings or communication links between the apparatuses or modules may be implemented in electrical, mechanical, or other forms.

The units described as discrete parts may or may not be physically separated, and parts displayed as units may or may not be physical units, i.e., they may be located at one position, or may be distributed over a plurality of network units. Some or all of the units may be selected based on actual requirements to fulfill the objectives of the solutions of the embodiments.

In addition, functional modules in respective embodiments of the present disclosure may be integrated into one processing module, or exist alone physically; alternatively, two or more modules may be integrated into one module.

The functions, when implemented in the form of software functional module and sold or used as an independent product, may be stored in a non-volatile computer-readable storage medium executable by the processor. Based on such understanding, the technical solutions of the present disclosure essentially, or the part of the technical solutions contributing to the prior art, or some of the technical solutions may be implemented in the form of software product. The computer software product is stored in a storage medium, and includes several instructions for enabling a computer device (which may be a personal computer, a server, a network device, or the like) to perform all or some of the steps of the methods described in the embodiments of the present disclosure. The foregoing storage medium includes any medium that can store program codes, such as USB flash drive, mobile hard disk, Read-Only Memory (ROM), Random Access Memory (RAM), magnetic disk, or optical disc.

In the end, it should be noted that the above embodiments are merely specific implementations of the present disclosure and intended to explain the technical solutions of the present disclosure, rather than restricting them. The protection scope of the present disclosure is not restricted to this. Although the present disclosure is described in details with reference to the foregoing embodiments, those ordinary skilled in the art should understand that any technical personnel familiar with the technical field can still modify the technical solutions disclosed by the above embodiments or easily conceive of the changes of these technical solutions or equivalently substitute some of the technical features therein within the technical scope disclosed by the present disclosure. However, these modifications, changes or substitutions would not deviate the corresponding technical solutions from the spirit and scope of the technical solutions according to the embodiments of the present disclosure and instead should be encompassed within the protection scope of the present disclosure. Therefore, the protection scope of the present disclosure should be subject to the protection scope of the claims.

1-14. (canceled)

15. An information recommendation method, comprising:
determining, in response to a search instruction for a first page, a product included in a multimedia content displayed on the first page;
displaying, on a second page, at least one e-commerce recommendation word, the e-commerce recommendation word being generated based on the product and a keyword corresponding to at least one e-commerce attribute feature;
receiving a trigger operation for the e-commerce recommendation word, and initiating, based on the e-commerce recommendation word and a vertical domain of content corresponding to the e-commerce recommendation word, a search request.

16. The method of claim 15, wherein the e-commerce attribute feature is determined by:
determining, in accordance with a product type of the product, respective service providers matching the product type;
determining, in accordance with current attribute state features of the determined respective service providers, the e-commerce attribute feature meeting a recommendation condition.

17. The method of claim 15, wherein the e-commerce recommendation word is determined by:
obtaining candidate recommendation words associated with the product;
selecting, from the candidate recommendation words, a candidate recommendation word that matches a determined e-commerce attribute feature as the e-commerce recommendation word.

18. The method of claim 15, wherein the multimedia content is a video, and determining a product included in a multimedia content displayed on the first page comprises:
extracting text descriptive information in the video, and determining, based on the text descriptive information, a product associated with the video; and/or
identifying each entity in respective key frame images of the video, and determining a product in each entity identified.

19. The method of claim 15, wherein the multimedia content is an image-text content describing a product, and determining a product included in a multimedia content displayed on the first page comprises:
determining, based on product descriptive information in the image-text content, a product associated with the image-text content; and/or performing product identification on an image in the image-text content, and determining a product identified.

20. The method of claim 15, further comprising:
when it is determined that the multimedia content includes a plurality of products, selecting, based on current behavior data for the first page and/or authorized historical behavior data of a user, a target product from the plurality of products to determine the e-commerce recommendation word.

21. The method of claim 15, wherein displaying, on a second page, at least one e-commerce recommendation word comprises:
displaying, in a first region of the second page, a first e-commerce recommendation word, the first region being a region corresponding to a search box;
displaying, in a second region of the second page, a second e-commerce recommendation word;
wherein a correlation between the first e-commerce recommendation word and the product is greater than a correlation between the second e-commerce recommendation word and the product.

22. The method of claim 21, wherein the e-commerce recommendation word further includes a third e-commerce recommendation word determined based on the e-commerce attribute feature and irrelevant to the product;
displaying, on a second page, at least one e-commerce recommendation word comprises:
displaying, in a third region of a second page, the third e-commerce recommendation word.

23. The method of claim 15, wherein the method, after initiating, based on the e-commerce recommendation word and a vertical domain of content corresponding to the e-commerce recommendation word, a search request, further comprises:
displaying, under the vertical domain of content of a third page, a search result corresponding to the e-commerce recommendation word.

24. A computer device, comprising: a processor, a memory, and a bus; wherein the memory stores machine-readable instructions executable by the processor; during operation of computer device, the processor communicates with the memory via the bus; the machine-readable instructions, when executed by the processor, perform steps of an information recommendation method comprising:
determining, in response to a search instruction for a first page, a product included in a multimedia content displayed on the first page;
displaying, on a second page, at least one e-commerce recommendation word, the e-commerce recommendation word being generated based on the product and a keyword corresponding to at least one e-commerce attribute feature;
receiving a trigger operation for the e-commerce recommendation word, and initiating, based on the e-commerce recommendation word and a vertical domain of content corresponding to the e-commerce recommendation word, a search request.

25. The computer device of claim 24, wherein the e-commerce attribute feature is determined by:
determining, in accordance with a product type of the product, respective service providers matching the product type;
determining, in accordance with current attribute state features of the determined respective service providers, the e-commerce attribute feature meeting a recommendation condition.

26. The computer device of claim 24, wherein the e-commerce recommendation word is determined by:
obtaining candidate recommendation words associated with the product;
selecting, from the candidate recommendation words, a candidate recommendation word that matches a determined e-commerce attribute feature as the e-commerce recommendation word.

27. The computer device of claim 24, wherein the multimedia content is a video, and determining a product included in a multimedia content displayed on the first page comprises:
extracting text descriptive information in the video, and determining, based on the text descriptive information, a product associated with the video; and/or
identifying each entity in respective key frame images of the video, and determining a product in each entity identified.

28. The computer device of claim 24, wherein the multimedia content is an image-text content describing a product, and determining a product included in a multimedia content displayed on the first page comprises:
determining, based on product descriptive information in the image-text content, a product associated with the image-text content; and/or performing product identification on an image in the image-text content, and determining a product identified.

29. The computer device of claim 24, wherein the method further comprises:
when it is determined that the multimedia content includes a plurality of products, selecting, based on current behavior data for the first page and/or authorized historical behavior data of a user, a target product from the plurality of products to determine the e-commerce recommendation word.

30. The computer device of claim 24, wherein displaying, on a second page, at least one e-commerce recommendation word comprises:
displaying, in a first region of the second page, a first e-commerce recommendation word, the first region being a region corresponding to a search box;
displaying, in a second region of the second page, a second e-commerce recommendation word;
wherein a correlation between the first e-commerce recommendation word and the product is greater than a correlation between the second e-commerce recommendation word and the product.

31. The computer device of claim 30, wherein the e-commerce recommendation word further includes a third e-commerce recommendation word determined based on the e-commerce attribute feature and irrelevant to the product;
displaying, on a second page, at least one e-commerce recommendation word comprises:
displaying, in a third region of a second page, the third e-commerce recommendation word.

32. The computer device of claim 24, wherein the method, after initiating, based on the e-commerce recommendation word and a vertical domain of content corresponding to the e-commerce recommendation word, a search request, further comprises:
displaying, under the vertical domain of content of a third page, a search result corresponding to the e-commerce recommendation word.

33. A computer-readable storage medium having computer programs stored thereon, the computer programs, when executed by a processor, perform steps of an information recommendation method comprising:
determining, in response to a search instruction for a first page, a product included in a multimedia content displayed on the first page;
displaying, on a second page, at least one e-commerce recommendation word, the e-commerce recommendation word being generated based on the product and a keyword corresponding to at least one e-commerce attribute feature;
receiving a trigger operation for the e-commerce recommendation word, and initiating, based on the e-commerce recommendation word and a vertical domain of content corresponding to the e-commerce recommendation word, a search request.

34. The computer-readable storage medium of claim 33, wherein the e-commerce attribute feature is determined by:
determining, in accordance with a product type of the product, respective service providers matching the product type;
determining, in accordance with current attribute state features of the determined respective service providers, the e-commerce attribute feature meeting a recommendation condition.
